(19) United States
(12) Patent Application Publication
(10) Pub. No.: US 2008/0087697 A1
(43) Pub. Date: Apr. 17, 2008

(54) Vehicle tissue-box container

(76) Inventor: Peter Hoenig, Lasalle (CA)

Correspondence Address: BLISS MCGLYNN, P.C., 2075 WEST BIG BEAVER ROAD, SUITE 600, TROY, MI, 48084, US

(21) Appl. No.: 11/580,416

(22) Filed: Oct. 13, 2006

(51) Int. Cl. B60R 7/00

(52) U.S. Cl. 224/275

(57) ABSTRACT

A tissue-box container is adapted to receive and support a box of tissues and be supported upon a surface of a passenger compartment of a vehicle. The container includes a casing adapted to receive and support the box. A cover is adapted to be removably secured to the casing to enclose the box and secure the box within the container and through which tissues of the box are dispensed. The container is adapted to substantially resist sliding along the surface of the passenger compartment during operation of the vehicle and permit a portion of the box to be exposed from exterior the container.

### BACKGROUND OF THE INVENTION

1. Field of the Invention

The present invention relates generally to a tissue-box container and, more particularly, to such a container especially adapted for use within a passenger compartment of a vehicle.

2. Description of the Related Art

It is known to contain a box of facial tissues, or just the tissues themselves, in a container from which the tissues can be manually dispensed. Although such a container can serve to protect the box and/or tissues from damage, the container generally serves an aesthetic purpose. More specifically, compared to the box itself, a particular container may more appropriately decorate the interior of a room or part of a room in which the box is located and used. As such, various rooms of, say, a house may include different respective containers to help accentuate the look of the corresponding rooms.

Since a person can spend much time of any given day in a vehicle, it is also known to locate and use a tissue box or a container therefor within a passenger compartment of the vehicle. When a container is employed with the box, in the same manner as described above in connection with use of containers in respective rooms of a house, compared to the box itself, a particular container may more appropriately decorate the interior of the passenger compartment.

More specifically, it is customary to support the box or container in an upright state on a floor, seat, dashboard, or center console of the passenger compartment within arm's-length reach of a driver or other occupant of the vehicle. This way, when the occupant desires to use a tissue, the occupant can easily and quickly access one from the box or container, assuming, of course, the box or container has not moved out of reach of the occupant during operation of the vehicle.

Unfortunately, however, acceleration of the vehicle or change in direction causes an external force to be applied to the box or container, often resulting in the box or container sliding along or off or tipping onto the floor, seat, dashboard, or center console. Also, any occupant of the vehicle can inadvertently make contact with the box or container. As a result, the box or container can be easily displaced out of reach of the occupant or from its upright state such that the tissues are no longer conveniently accessible to the occupant. In fact, such a situation can create a dangerous driving environment when the driver of the vehicle takes his or her eyes off the road and/or hands off the steering wheel to locate and retrieve a sufficiently displaced box or container.

Thus, there is a need in the related art for a tissue-box container that is especially adapted for use within a passenger compartment of a vehicle. More specifically, there is a need in the related art for such a container that is not easily displaced from a stationary position of the container within such compartment during acceleration of the vehicle.

### SUMMARY OF THE INVENTION

The present invention overcomes the disadvantages in the related art in a tissue-box container adapted to receive and support a box of tissues and be supported upon a surface of a passenger compartment of a vehicle. The container includes a casing adapted to receive and support the box. A cover is adapted to be removably secured to the casing to enclose the box and secure the box within the container and through which tissues of the box are dispensed. The container is adapted to substantially resist sliding along the surface of the passenger compartment during operation of the vehicle and permit a portion of the box to be exposed from exterior the container.

One advantage of the tissue-box container of the present invention is that it is especially adapted for use within a passenger compartment of a vehicle.

Another advantage of the vehicle tissue-box container of the present invention is that it is not easily displaced from a stationary position of the container within such compartment during operation of the vehicle.

Another advantage of the vehicle tissue-box container of the present invention is that it permits a portion of the box to be exposed from exterior the container.

Another advantage of the vehicle tissue-box container of the present invention is that it is adapted to operatively substantially conform to the shape of the surface of the passenger compartment upon which the container is supported.

Another advantage of the vehicle tissue-box container of the present invention is that it, compared to the box itself, may more appropriately decorate the interior of the passenger compartment.

Another advantage of the vehicle tissue-box container of the present invention is that it can be fastened on a seat of the passenger compartment of the vehicle by a seatbelt.

Other objects, features, and advantages of the present invention will be readily appreciated as the same becomes better understood while reading the subsequent description taken in conjunction with the accompanying drawings.

### BRIEF DESCRIPTION OF THE DRAWINGS

FIG. 1 is an environmental view of the vehicle tissue-box container of the present invention showing the container supported about a hump of the passenger compartment of the vehicle.

FIG. 2 is another environmental view of the vehicle tissue-box container of the present invention showing the container fastened on a seat of the passenger compartment of the vehicle by a seatbelt.

FIG. 3 is a perspective top view of one embodiment of the vehicle tissue-box container of the present invention.

FIG. 4 is a perspective bottom view of the embodiment of the vehicle tissue-box container of the present invention shown in FIG. 3.

FIG. 5 is an exploded assembly view of the embodiment of the vehicle tissue-box container of the present invention shown in FIG. 3.

FIG. 6 is an isolated fragmentary view taken along the line “6-6” in FIG. 5 illustrating the cover removably secured to the casing of the embodiment of the vehicle tissue-box container of the present invention shown in FIG. 3.

FIG. 7 is an exploded assembly view of another embodiment of the vehicle tissue-box container of the present invention.

FIG. 8 is an isolated fragmentary view taken along the line “8-8” in FIG. 7 illustrating the cover removably secured to the casing of the embodiment of the vehicle tissue-box container of the present invention shown in FIG. 7.

### DETAILED DESCRIPTION OF THE INVENTION

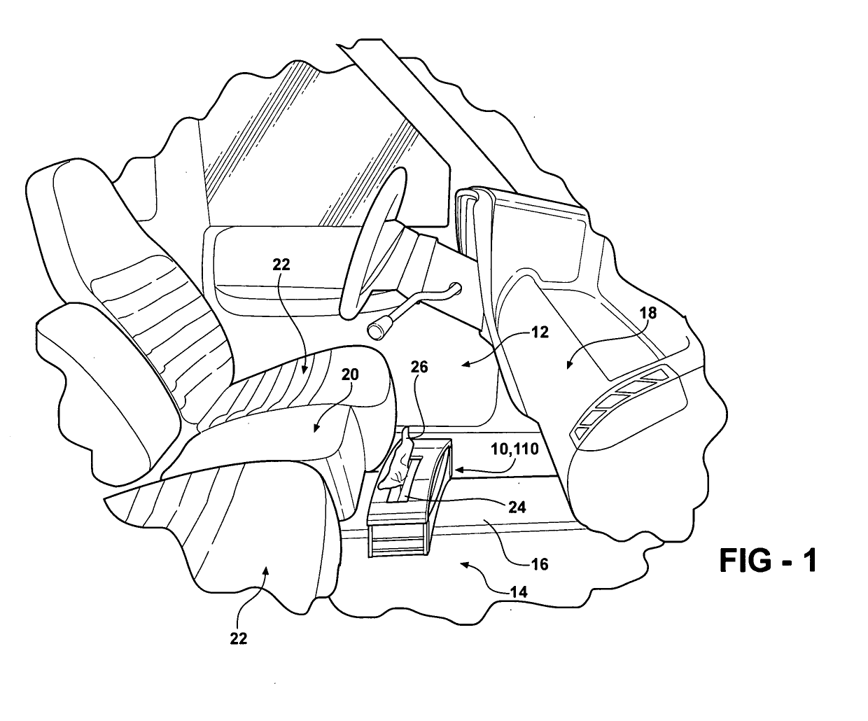

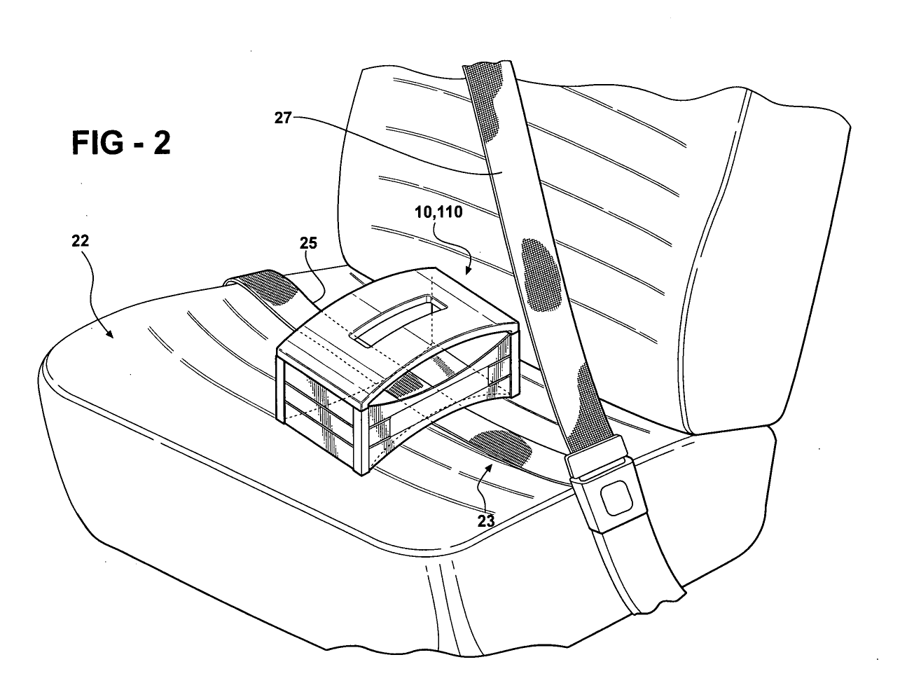

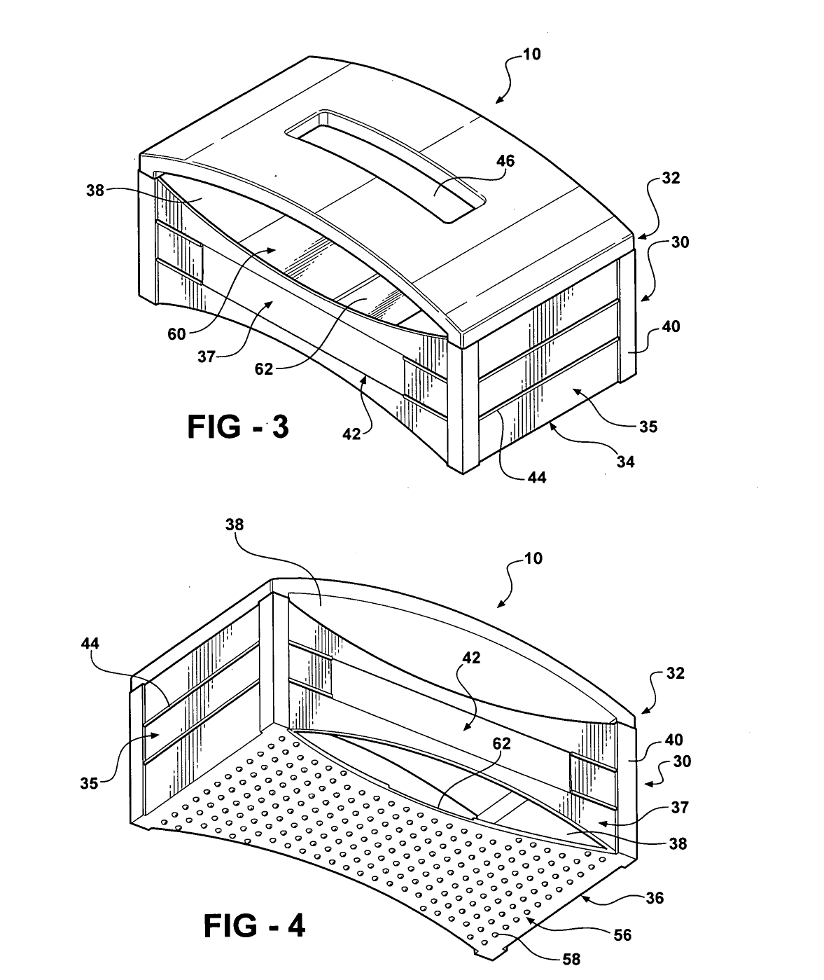

Referring now to the figures, where like numerals are used to designate like structure, one embodiment of a tissue-box container of the present invention is generally indicated at 10 and shown in operation within a passenger compartment, generally indicated at 12, of a vehicle in FIGS. 1 and 2 and per se in FIGS. 3-5. More specifically, in FIG. 1, the container 10 is shown, in general, supported in its upright state on a surface, generally indicated at 14, of the passenger compartment 12 and, in particular, about a hump 16. The hump 16 extends substantially uniformly from below a dashboard, generally indicated at 18, to a center console or arm rest, generally indicated at 20, located between a driver's seat and a front passenger's seat, generally indicated at 22. A box 24 of facial tissues 26 is shown received and supported within the container 10 such that a tissue 26 extends from the box 24 and, thus, container 10 to be easily and quickly manually taken by a driver or other front-seat occupant of the vehicle. As such, the container 10 is shown located closer to the seats 22 than to the dashboard 18. In FIG. 2 and as described in detail below, the container 10 is shown fastened in its upright state on the front passenger's seat 22 by a seatbelt, generally indicated at 23. The seatbelt 23 includes a lap portion 25 and a harness portion 27. In FIG. 2, the box 24 is not shown received and supported within the container 10 so as to illustrate structural relationship of the seatbelt 23 with the container 10.

As described in detail below, the container 10 is adapted to substantially resist sliding along the hump 16 or front passenger's seat 22 during operation of the vehicle. In this way, any external forces applied to the container 10 via acceleration/deceleration of the vehicle or change in direction, does not result in the container 10 sliding off the hump 16 or front passenger's seat 22 or tipping onto any portion of the surface 14 disposed adjacent the hump 16 and front passenger's seat 22. Also, any inadvertent contact with the container 10 by the occupant does not result in the container 10 being easily displaced out of his or her reach or from its upright state such that the tissues 26 are no longer conveniently accessible to the occupant. As a result, use of the container 10 does not create a dangerous driving environment in which the driver must take his or her eyes off the road and/or hands off the steering wheel to locate and retrieve the container 10.

As also described in detail below, the container 10 is adapted to permit a portion of the box 24 to be exposed from exterior the container 10. In this way, the occupant can easily and quickly determine whether the container 10 is operational without him or her having to remove any part of the container 10.

It should be appreciated by those having ordinary skill in the related art that the container 10 can be positioned in any suitable location of the passenger compartment 12. It should also be appreciated that the container 10 can be employed in any suitable vehicle. It should also be appreciated that the container 10 can be employed in any suitable setting in which any suitable external force may act upon the container 10 to otherwise displace it from its position. It should also be appreciated that the container 10 can be supported on any suitable surface or seat. It should also be appreciated that the container 10 can be fastened by any suitable seatbelt. It should also be appreciated that the container 10 can be employed with any suitable box of tissues. It should also be appreciated that the container 10 can include any suitable exterior decorative design.

Referring now to FIGS. 3 through 5 and 7, the container 10 includes, in general, a casing, generally indicated at 30 adapted to receive and support the box 24. A cover, generally indicated at 32, is adapted to be removably secured to the casing 30 to enclose the box 24 and secure the box 24 within the container 10 and through which the tissues 26 of the box 24 are dispensed.

More specifically, the casing 30 includes at least one wall, generally indicated at 34 in FIG. 3 and a bottom side, generally indicated at 36 in FIG. 4, adapted to cover a lower opening defined by the wall(s) 34, support a bottom side of the box 24, and be supported upon the hump 16. As described in greater detail below, at least one of the walls 34, cooperates with the cover 32 and/or bottom side 36 to define at least one opening 38 that permits the portion of the box 24 to be exposed from exterior the container 10 through the opening 38. As shown, the container 10 defines an opening 38 disposed between a wall 34 and the cover 32 and another opening 38 disposed between the wall 34 and the bottom side 36.

As shown, the casing 30 includes a plurality of walls 34. In particular, the casing 30 includes a pair of opposed end walls, generally indicated at 35, and a pair of opposed side walls, generally indicated at 37, extending between the respective pair of end walls 35. The casing 30 also includes a corner post 40 disposed at the imaginary intersection of each end wall 35 with each side wall 37 and defining a substantially rectangular transverse cross-section. The posts 40 are disposed integral with the corresponding end and side walls 35, 37 and jut slightly outward with respect to such walls 35, 37. The pair of end walls 35 are disposed substantially parallel with each other, the pair of side walls 37 are disposed substantially parallel with each other and perpendicular to the pair of end walls 35, and the bottom side 36 is disposed substantially perpendicular to the end and side walls 35, 37 and corner posts 40 such that the casing 30 defines a substantially rectangular cross-section. The end walls 35 are substantially identical with respect to each other, and the side walls 37 are substantially identical with respect to each other. Each corner post 40 is substantially uniform, and the corner posts 40 are substantially identical with respect to each other. The respective ends of the end and side walls 35, 37 and the corners of the bottom side 36 are disposed substantially flush with the corresponding corner posts 40.

Each wall 34 also defines an exterior surface, generally indicated at 42, of the wall 34. The exterior surface 42 is substantially planar and smooth and defines at least one rib 44 adapted to provide structural integrity to the casing 30. As shown, each wall 34 defines a plurality of substantially identical ribs 44 disposed substantially parallel with each other and perpendicular to the corner posts 40 and substantially symmetrical with the corresponding wall 34. Each rib 44 is substantially linear and uniform and disposed integral with the corresponding wall 34. Each rib 44 of each end wall 35 integrally extends from one corner post 40 to the other corner post 40 in a flush manner while each rib 44 of each side wall 37 integrally extends only partially from one corner post 40 in a flush manner toward the other corner post 40 such that an open area of the side wall 37 is defined upon which any advertising, commercial, or promotional material may be applied to the container 10.

It should be appreciated by those having ordinary skill in the related art that the casing 30 can have any suitable shape, size, and structure and structural relationship with the cover 32. It should also be appreciated that the casing 30 can include any suitable number of walls 34 and corresponding corner posts 40. For example, the casing 30 can include only one wall 34 to define a substantially circular cross-section or three walls 34 to define a substantially triangular cross-section. It should also be appreciated that each wall 34 can have any suitable shape, size, and structure and structural relationship with each of any other walls 34, the corner posts 40, the cover 32, and the bottom side 36. It should also be appreciated that each corner post 40 can have any suitable shape, size, and structure and structural relationship with each of the corresponding walls 34, the cover 32, and the bottom side 36. It should also be appreciated that each wall 34 can define any suitable number of ribs 44. It should also be appreciated that each rib 44 can have any suitable shape, size, and structure and structural relationship with each of any other rib 44, the corresponding wall 34, and the corner posts 40.

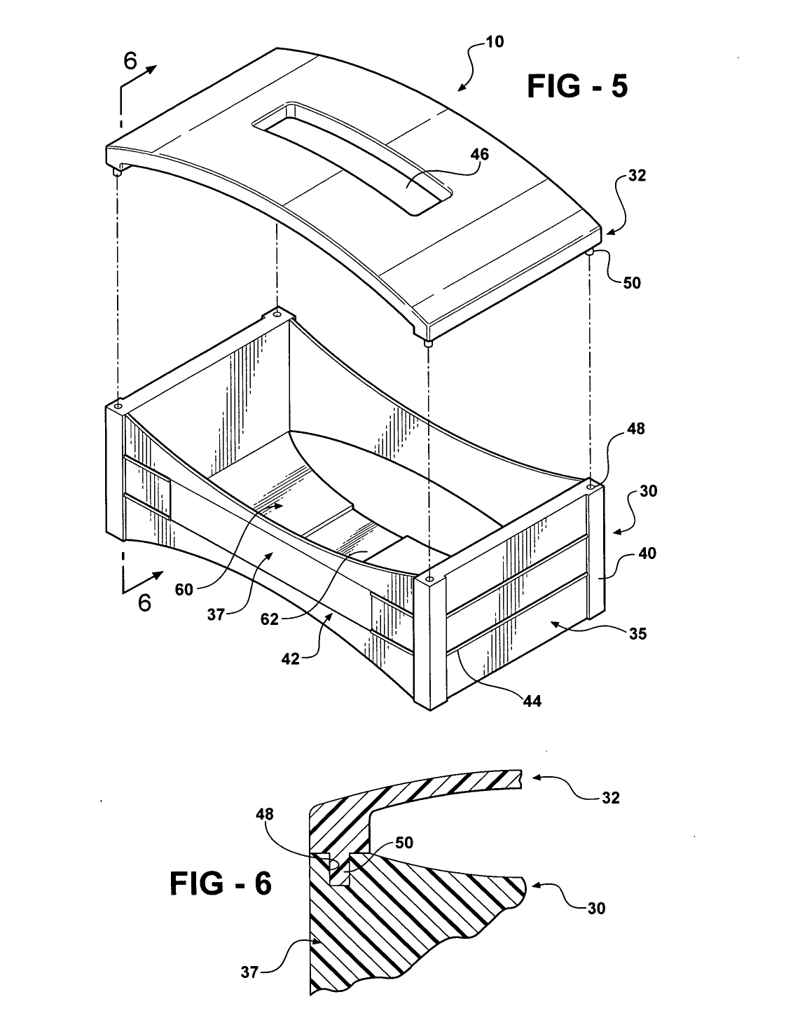

As shown in FIGS. 3 and 5, the cover 32 is substantially smooth and dome-shaped and operatively disposed substantially concave with respect to the casing 30 and flush with the corner posts 40. The cover 32 also defines an aperture 46 through which the tissues 26 of the box 24 are dispensed. The aperture 46 is defined completely through a substantially central volume of the cover 32 and defines a substantially rectangular cross-section.

It should be appreciated by those having ordinary skill in the related art that the cover 32 can have any suitable shape, size, and structure and structural relationship with each of the casing 30 and box 24, in general, and corner posts 40, in particular. It should also be appreciated that the aperture 46 can have any suitable shape and size and structural relationship with the container 10, in general, and each of the cover 32 and box 24, in particular.

As shown, each of the side walls 37 and the cover 32 cooperate to define an opening 38 disposed between the side wall 37 and cover 32. Also, each of the side walls 37 and the bottom side 36 cooperate to define another opening 38 disposed between the side wall 37 and the bottom side 36. Respective openings 38 of opposed side walls 37 are substantially identical with respect to each other. Each opening 38 disposed between the side wall 37 and cover 32 is substantially bi-convex and extends substantially from one corner post 40 to the other corner post 40. Each opening 38 disposed between the side wall 37 and bottom side 36 is substantially plano-convex (the convex side of the opening 38 being disposed opposite the bottom side 36 of the casing 30), extends substantially from one corner post 40 to the other corner post 40, and has its convex side disposed substantially symmetrical with the nearest convex side of the opening 38 disposed between the side wall 37 and cover 32.

It should be appreciated by those having ordinary skill in the related art that the casing 30 can define any suitable number of openings 38. It should also be appreciated that each opening 38 can have any suitable shape and size and structural relationship with each of the casing 30 and cover 32.

Referring now to FIGS. 5 and 6, each end wall 35 defines a hole 48 extending in and at least partially through a top of each corner post 40, and the cover 32 defines a projection 50 extending from a bottom of each corner of the cover 32. Each hole 48 is adapted to matingly receive a corresponding projection 50 to removably secure the cover 32 to the casing 30.

The holes 48 are substantially identical with respect to each other and defined in a substantially central area/volume of the top of the respective corner posts 40. The depth of each hole 48 is substantially small relative the height of the corner post 40, and the diameter of each hole 48 is substantially smaller than the length/width of the corner post 40. Likewise, the projections 50 are substantially identical with respect to each other. The length of each projection 50 is smaller than the height of the corner of the cover 32.

It should be appreciated by those having ordinary skill in the related art that each end wall 35 can define any suitable number of holes 48. It should also be appreciated that any suitable wall 34 can define the holes 48. It should also be appreciated that each hole 48 can have any suitable shape and size and structural relationship with each of the casing 30 and cover 32. It should also be appreciated that each projection 50 can have any suitable shape, size, and structure and structural relationship with each of the cover 32 and casing 30. It should also be appreciated that the casing 30 can define the projections 50, and the cover 32 can define the holes 48. It should also be appreciated that the cover 32 can be removably secured to the casing 30 by any suitable means.

Referring now to FIG. 4, the bottom side 36 of the casing 30 includes an outer surface, generally indicated at 56, that cooperates with the hump 16 of the passenger compartment 12 to define a coefficient of static friction of a magnitude such that the bottom side 36 substantially resists sliding along the hump 16 during operation of the vehicle. To this end, the outer surface 56 includes a plurality of raised surfaces 58 adapted to facilitate frictional contact between the outer surface 56 and the hump 16.

More specifically, each raised surface 58 is substantially uniform, and the raised surfaces 58 are substantially identical with respect to each other and uniformly distributed on the outer surface 56. The raised surfaces 58 are preferably made of a suitable plastic or rubber material. However, it should be appreciated by those having ordinary skill in the related art that the outer surface 56 can cooperate with the hump 16 to define any suitable coefficient of static friction. It should also be appreciated that the outer surface 56 can include any suitable number of raised surfaces 58. It should also be appreciated that each raised surface 58 can have any suitable shape, size, structure and structural relationship with the outer surface 56. It should also be appreciated that the raised surfaces 58 can be made of any suitable material.

As shown in FIG. 1, the bottom side 36 of the casing 30 is adapted to operatively substantially conform to the shape of the hump 16 upon which the container 10 is supported. To this end, the bottom side 36 is adapted to sufficiently yield in the general direction toward and away from the cover 32 so as to conform to the shape of any surface upon which the container 10 is supported. Those having ordinary skill in the related art should appreciate that the bottom side 36 also can be designed to be disposed substantially convex with respect to the interior of the casing 30 such that the bottom side 36 operatively correspondingly abuts the hump 16 upon which the container 10 is supported. Either way, as shown in FIGS. 1, 3, and 5, the bottom side 36 is substantially parallel with the cover 32. It should be appreciated by those having ordinary skill in the related art that the bottom side 36 can be designed to take the shape of any suitable surface upon which the container 10 is supported.

As shown in FIGS. 3-5, the bottom side 36 of the casing 30 includes an interior surface, generally indicated at 60, adapted to support the bottom side of the box 24. As such, the interior surface 60 is substantially rectangular, smooth, and co-extensive with the bottom side of the box 24. The interior surface 60 defines an indentation 62 extending across a substantially central area of the interior surface 60 from one side wall 37 to the other side wall 37. The indentation 62 is substantially uniform and perpendicular to the pair of side walls 37. As shown in FIG. 2, the indentation 62 is adapted to operatively receive the lap portion 25 of the seatbelt 23 such that the container 10 can be fastened on the front passenger's seat 22 by the seatbelt 23.

More specifically, the indentation 62 defines a width and depth of the indentation 62 that are substantially equal to those of the lap portion 25 such that the interior surface 60 is substantially planar when the seatbelt 23 is employed. To employ the seatbelt 23, it enters one opening 38 and exits the other opening 38 such that the lap portion 25 is operatively disposed within the indentation 62 and the harness portion 27 extends over the cover 32. In this way, the lap portion 25 applies a substantially downward force to the casing 30, and the harness portion 27 can, depending upon the structural relationship of the harness portion 27 with the front passenger's seat 22, apply a force (not shown), which defines a component of the force directed substantially downwardly, to the cover 32 to fasten the container 10 on the front passenger's seat 22.

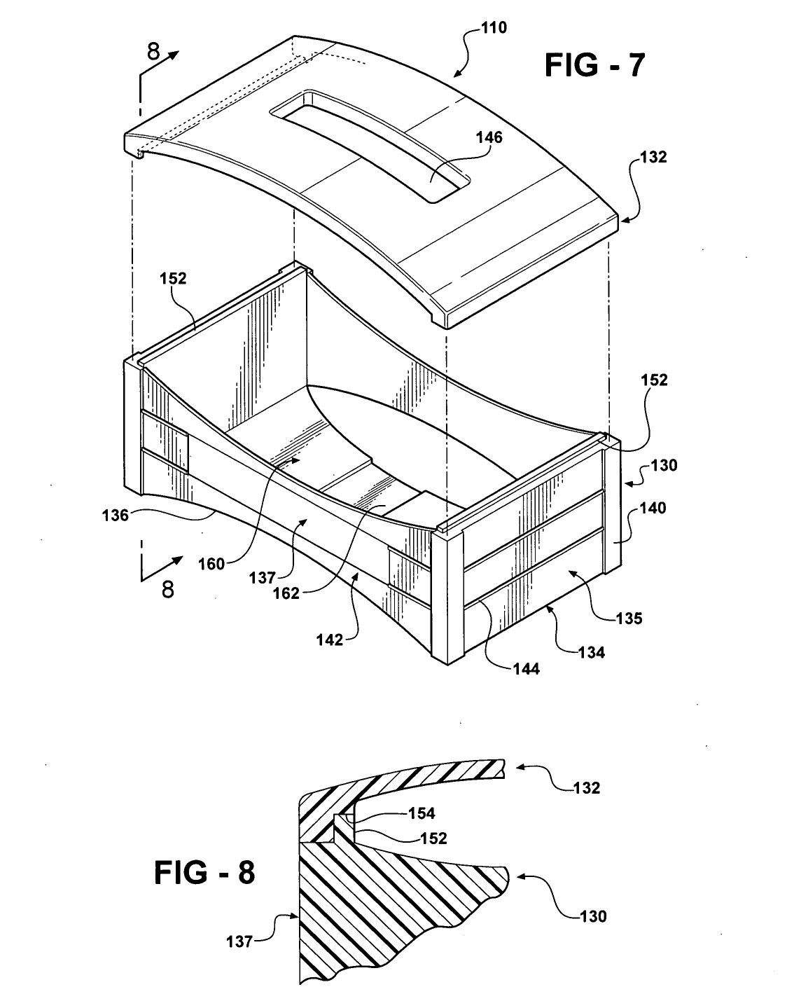

Referring now to FIGS. 7 and 8, another embodiment of the container is generally indicated at 110. Similar or like parts of the container 110 with respect to the container 10 have similar or like reference numerals as those of the container 10 increased by one hundred (100). However, since structure relating to removably securing the cover 132 to the casing 130 vis-a-vis the structure relating to removably securing the cover 32 to the casing 30 is the only difference between the container 110 and the container 10, respectively, only this difference is described immediately below.

As shown in FIGS. 7 and 8, each end wall 135 defines a substantially uniform ridge 152 extending along at least a portion of a top of the end wall 135, and each end of the cover 132 defines at least one groove 154 extending along at least a portion of a bottom of the cover 132. Each groove 154 is adapted to receive a corresponding ridge 152 to removably secure the cover 132 to the casing 130.

The ridges 152 are substantially identical with respect to each other, and each ridge 152 extends substantially from one corner post 140 to the other corner post 140. The height of each ridge 152 is substantially small relative the height of the end wall 135, and the width of each ridge 152 is substantially smaller than the width of the end wall 135. Likewise, the grooves 154 are substantially identical with respect to each other, and each groove 154 extends substantially from one side of the cover 132 to the other side of the cover 132. The depth of each groove 154 is substantially small relative the height of the end of the cover 132, and the width of each groove 154 is substantially smaller than the width of the end of the cover 132.

It should be appreciated by those having ordinary skill in the related art that each end wall 135 can define any suitable number of ridges 152. It should also be appreciated that any suitable wall 134 can define the ridge(s) 152. It should also be appreciated that each ridge 152 can have any suitable shape, size, and structure and structural relationship with each of the casing 130 and cover 132. It should also be appreciated that each groove 154 can have any suitable shape and size and structural relationship with the cover 132 and casing 130. It should also be appreciated that the casing 130 can define the grooves 154, and the cover 132 can define the ridges 152.

In operation, a user of the container 10, 110 checks the interior of the container 10, 110 through an opening 38, 138 to determine whether the container 10, 110 is loaded with a box 24 of tissues 26 (or just tissues 26 themselves). If the container 10, 110 is not so loaded, then a box 24 of tissues 26 is (or just the tissues 26 themselves are) received and supported in the casing 30, 130. The cover 32, 132 is then secured to the casing 30, 130 to enclose the box 24 (or just the tissues 26 themselves) and secure the box 24 (or just the tissues 26 themselves) within the container 10, 110 such that a tissue 26, which is to be dispensed from the container 10, 110, extends through the aperture 46, 146 of the cover 32, 132. In either case, the container 10, 110 is positioned in its upright state on the hump 16 within arm's-length reach of the front-seat occupant(s) such that the bottom side 36, 136 of the casing 30, 130 operatively correspondingly abuts the hump 16. Alternatively, the container 10, 110 is positioned in its upright state on the front passenger's seat 22 within arm's-length reach of the driver such that the container 10, 110 is fastened on the seat 22 by the seatbelt 23. Then, the container 10, 110 is loaded with a box 24 of tissues 26 (or just tissues 26 themselves).

During operation of the vehicle, because of the magnitude of the coefficient of static friction defined between the bottom side 36, 136 and hump 16 or substantially downward force applied by the seatbelt 23 to the container 10, 110, the container 10, 110 remains substantially in this position. When an occupant desires to use the tissue 26, he or she just reaches to and conveniently manually takes it. In so doing, the driver does not need to take his or her eyes off the road and/or hands off the steering wheel, and the occupant does not need to expend any unnecessary time and energy attempting to retrieve the container 10, 110.

The container 10, 110 is especially adapted for use within the passenger compartment 12 of the vehicle. More specifically, the container 10, 110 is not easily displaced from a stationary position of the container 10, 110 within the passenger compartment 12 during operation of the vehicle. Also, the container 10, 110 permits a portion of the box 24 to be exposed from exterior the container 10, 110. Furthermore, the container 10, 110 is adapted to operatively substantially conform to the shape of the surface 14 of the passenger compartment 12 upon which the container 10, 110 is supported. In addition, the container 10, 110, compared to the box 24 itself, may more appropriately decorate the interior of the passenger compartment 12. Moreover, the container 10, 110 can be fastened on a seat of the passenger compartment of the vehicle by a seatbelt.

The present invention has been described in an illustrative manner. It is to be understood that the terminology that has been used is intended to be in the nature of words of description rather than of limitation. Many modifications and variations of the present invention are possible in light of the above teachings. Therefore, within the scope of the appended claims, the present invention may be practiced other than as specifically described.

I claim:

1. A tissue-box container adapted to receive and support a box of tissues and be supported upon a surface of a passenger compartment of a vehicle, said container comprising:
a casing adapted to receive and support the box; and
a cover adapted to be removably secured to said casing to enclose the box and secure the box within said container and through which tissues of the box are dispensed, wherein said container is adapted to substantially resist sliding along the surface of the passenger compartment during operation of the vehicle and permit a portion of the box to be exposed from exterior said container.

2. A tissue-box container as set forth in claim 1, wherein said casing includes at least one wall and a bottom side adapted to cover an opening defined by said at least one wall, support a bottom side of the box, and be supported upon the surface of the passenger compartment.

3. A tissue-box container as set forth in claim 2, wherein said at least one wall cooperates with at least one of said cover and bottom side to define at least one opening that permits the portion of the box to be exposed from exterior the container through said opening.

4. A tissue-box container as set forth in claim 3, wherein said at least one wall includes a pair of opposed end walls and a pair of opposed side walls respectively connected to and extending between said pair of end walls.

5. A tissue-box container as set forth in claim 4, wherein said pair of end walls are disposed substantially parallel with each other, said pair of side walls are disposed substantially parallel with each other and perpendicular to said pair of end walls, and said bottom side is disposed substantially perpendicular to said end and side walls such that said casing defines a substantially rectangular cross-section.

6. A tissue-box container as set forth in claim 4, wherein at least one of said side walls and said cover cooperate to define said opening disposed between said at least one of said side walls and said cover that permits the portion of the box to be exposed from exterior said container through said opening.

7. A tissue-box container as set forth in claim 2, wherein said at least one wall defines at least one ridge extending along at least a portion of a top of said at least one wall and said cover defines at least one groove extending along at least a portion of a bottom of said cover, said at least one groove being adapted to receive corresponding said at least one ridge to removably secure said cover to said casing.

8. A tissue-box container as set forth in claim 2, wherein said at least one wall defines at least one hole extending in and at least partially through a top of said at least one wall and said cover defines at least one projection extending from a bottom of said cover, said at least one hole being adapted to matingly receive corresponding said at least one projection to removably secure said cover to said casing.

9. A tissue-box container as set forth in claim 2, wherein said bottom side includes an outer surface that cooperates with the surface of the passenger compartment to define a coefficient of static friction of a magnitude such that said bottom side substantially resists sliding along the surface of the passenger compartment during operation of the vehicle.

10. A tissue-box container as set forth in claim 9, wherein said outer surface of said bottom side includes a plurality of raised surfaces adapted to facilitate frictional contact between said outer surface of said bottom side and the surface of the passenger compartment.

11. A tissue-box container as set forth in claim 2, wherein said bottom side is adapted to operatively substantially conform to the shape of the surface of the passenger compartment upon which said container is supported.

12. A tissue-box container as set forth in claim 2, wherein said bottom side is disposed substantially convex with respect to said casing such that said bottom side operatively correspondingly abuts the surface of the passenger compartment upon which said container is supported.

13. A tissue-box container as set forth in claim 1, wherein said cover defines an aperture through which the tissues of the box are dispensed.

14. A tissue-box container as set forth in claim 1, wherein said cover is operatively disposed substantially concave with respect to said casing.

15. A tissue-box container as set forth in claim 1, wherein said casing defines an exterior surface of said casing, said exterior surface defining at least one rib adapted to provide structural integrity to said casing.

16. A tissue-box container as set forth in claim 1, wherein said casing defines an interior surface of said casing, said interior surface defining an indentation adapted to operatively receive a seatbelt such that said container can be fastened on said surface by said seatbelt.
